(19) United States
(12) Patent Application Publication
(10) Pub. No.: US 2024/0267691 A1
(43) Pub. Date: Aug. 8, 2024

(54) SYSTEMS AND METHODS FOR AN AUDIO SYSTEM

(71) Applicant: Harman International Industries, Incorporated, Stamford, CT (US)

(72) Inventors: Kevin J. Bastyr, Franklin, MI (US); Joy Lyons, Lake Forest Park, WA (US); Jason Riggs, Stamford, CT (US)

(21) Appl. No.: 18/165,836

(22) Filed: Feb. 7, 2023

(51) Int. Cl. H04S 7/00; H04R 3/14; H04R 5/02; H04R 5/04

(52) U.S. Cl. CPC H04S 7/301; H04R 3/14; H04R 5/02; H04R 5/04; H04S 7/303; H04S 7/307; H04R 2201/021; H04S 2400/13; H04S 2400/15

(57) ABSTRACT

An audio system for controlling and modifying an audio signal in a room having selectively reconfigurable architecture is disclosed. The audio system comprises a plurality of speakers mounted to an architecture configuration having one or more movable room-defining components and a control system in electronic communication with the plurality of speakers and the one or more movable room-defining components.

The control system is configured to adjust one or more tuning parameters of one or more of the plurality of speakers based a position of the one or more movable room-defining components.

### FIELD

The disclosure relates to an audio system and methods for controlling and modifying an audio output for a room having movable architecture.

### BACKGROUND

An integral audio system can provide high quality audio performance for a living space. As a few examples, the structure of a room, surface materials, furniture, and human presence and preferences, may be considered when tuning the integral audio system to the environment.

Living spaces having reconfigurable architecture provide occupants flexibility in a compact footprint. In some examples, the living spaces may be configured to operate in several modes corresponding to different use cases or tasks of the occupant. An occupant may desire an integral audio system in such living spaces; however, as the architecture transforms from one arrangement to a next, the audio experience may not be optimal due to the room configuration.

### SUMMARY

Embodiments are disclosed for an integral audio system implemented in an environment with a movable architecture. In one aspect, an audio system for controlling and modifying an audio signal in a room having selectively reconfigurable architecture is disclosed. The audio system comprises a plurality of speakers mounted to an architecture configuration having one or more movable room-defining components and a control system in electronic communication with the plurality of speakers and the one or more movable room-defining components. The control system is configured to adjust one or more tuning parameters of one or more of the plurality of speakers based a position of the one or more movable room-defining components.

In another aspect, a method for a movable architecture is disclosed. The method comprises receiving an architecture configuration signal, modifying one or more tuning parameters of an audio system based on the architecture configuration signal, and generating an audio output with the modified tuning parameters.

In another aspect, a method for a movable architecture is presented, the movable architecture comprising an architecture configuration having one or more movable room-defining components and fixed room-defining components, a plurality of speakers mounted to the architecture configuration, and a plurality of use modes. The method comprises, in a first mode, where a movable wall unit and a movable table are in a first configuration, activating a first set of speakers, adjusting the first set of speakers to a first set of tuning parameters based on the first configuration of the movable wall unit and the movable table, and generating an audio output. In a second mode, where the movable wall unit and the movable table are in a second configuration, the method includes activating a second set of speakers, adjusting the second set of speakers to a second set of tuning parameters based on the second configuration of the movable wall unit and the movable table, and generating an audio output.

In this way, a high-quality audio experience may be generated for the movable architecture in various configurations.

### BRIEF DESCRIPTION OF THE DRAWINGS

The disclosure may be better understood from reading the following description of non-limiting embodiments, with reference to the attached drawings, wherein below:

FIG. 1 shows an audio system for a room having movable architecture in accordance with one or more embodiments of the present disclosure;

FIG. 2 shows a flow chart for a method for adjusting tuning parameters of an audio system in accordance with one or more embodiments of the present disclosure;

FIG. 3 shows a look-up table for a method for adjusting tuning parameters of an audio system in accordance with one or more embodiments of the present disclosure;

FIG. 4 shows a first mode an audio system for a room having movable architecture in accordance with one or more embodiments of the present disclosure;

FIG. 5 shows a second mode an audio system for a room having movable architecture in accordance with one or more embodiments of the present disclosure;

FIG. 6 shows a third mode an audio system for a room having movable architecture in accordance with one or more embodiments of the present disclosure;

FIG. 7 shows a fourth mode an audio system for a room having movable architecture in accordance with one or more embodiments of the present disclosure;

FIG. 8A shows a fifth mode of an audio system for a room having movable architecture in accordance with one or more embodiments of the present disclosure; and

FIG. 8B shows a sixth mode of an audio system for a room having movable architecture in accordance with one or more embodiments of the present disclosure.

### DETAILED DESCRIPTION

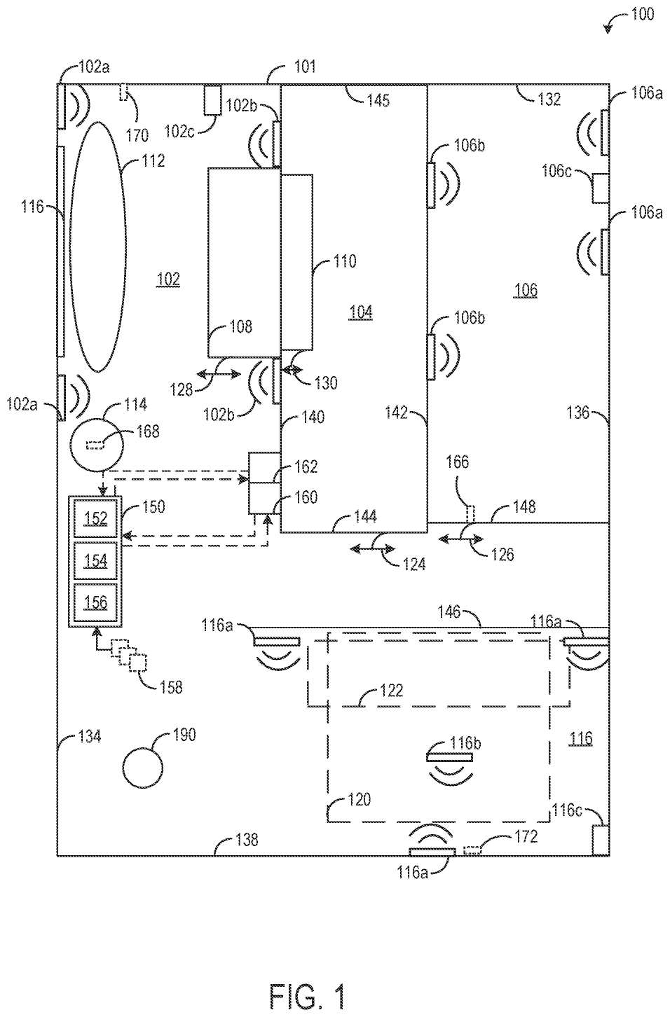

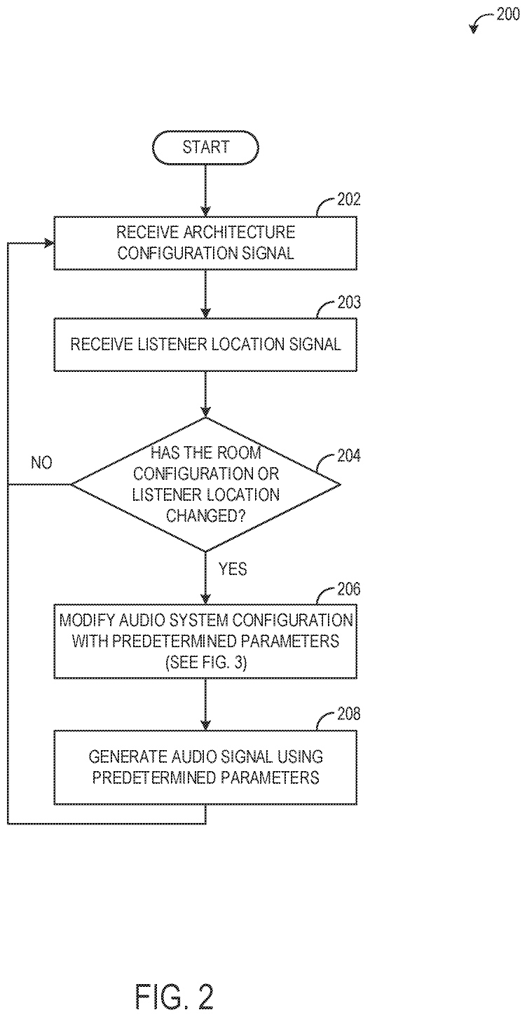

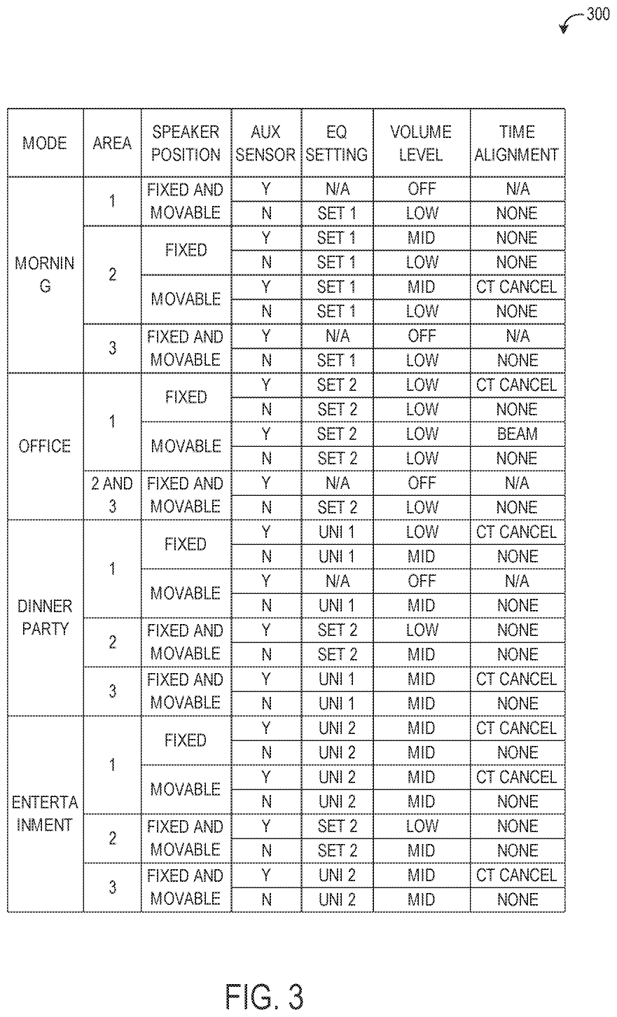

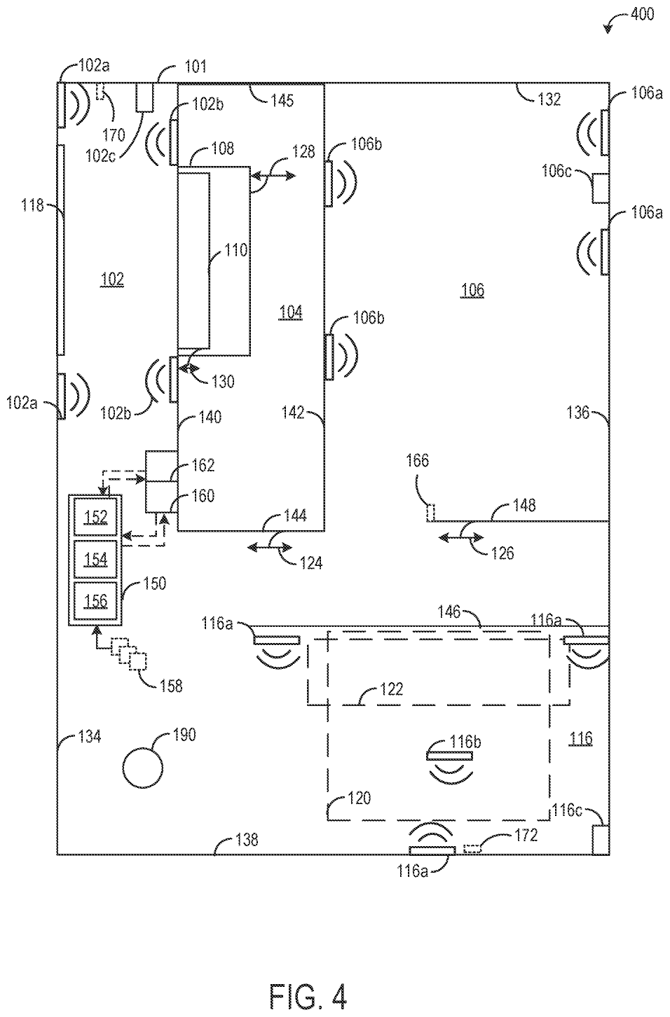

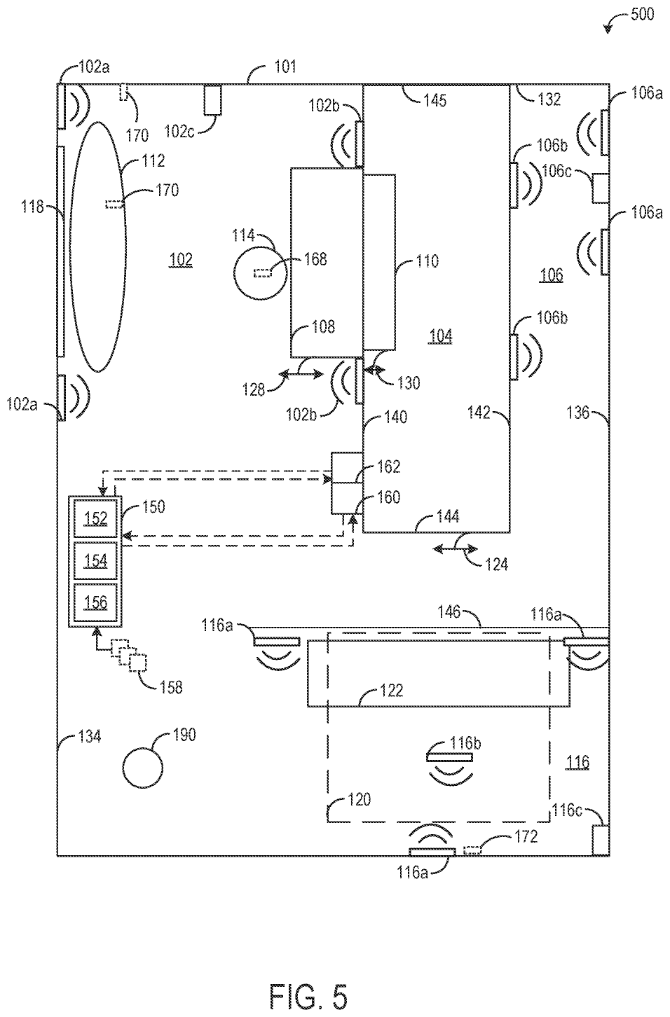

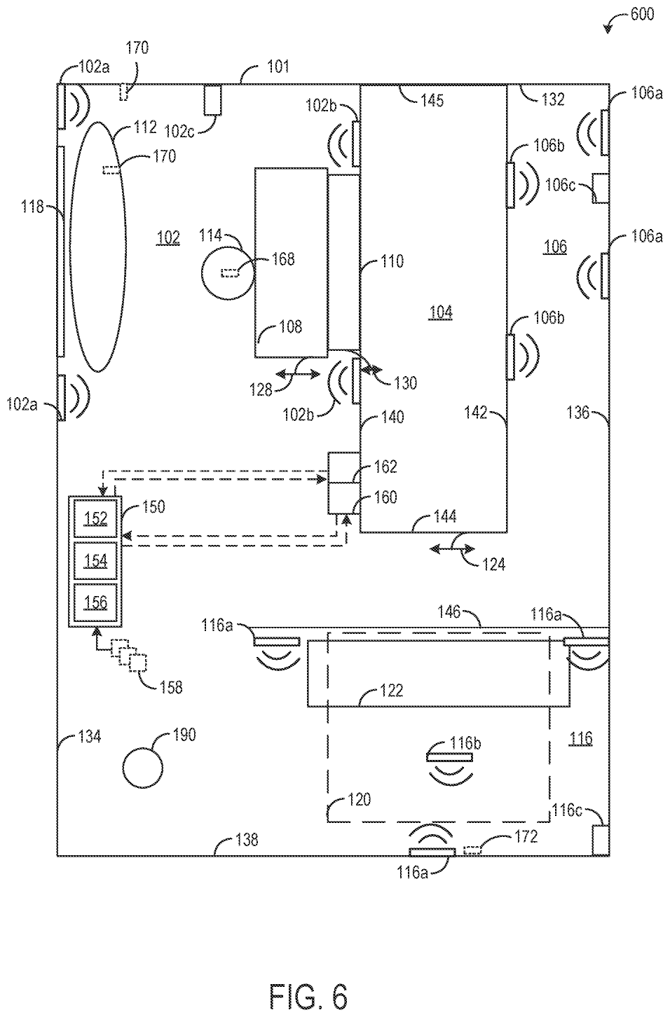

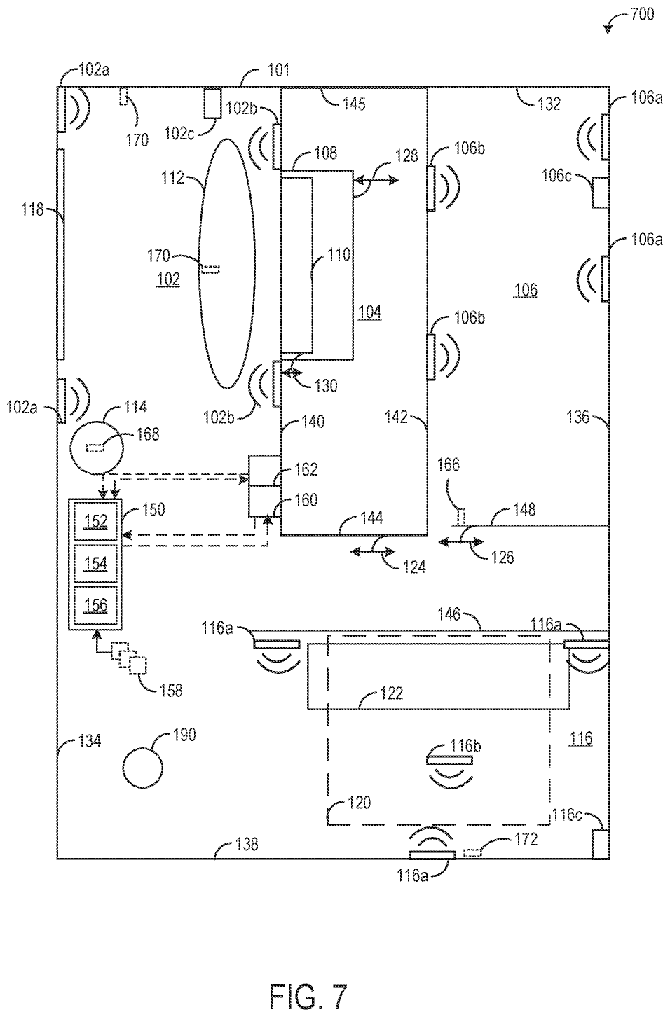

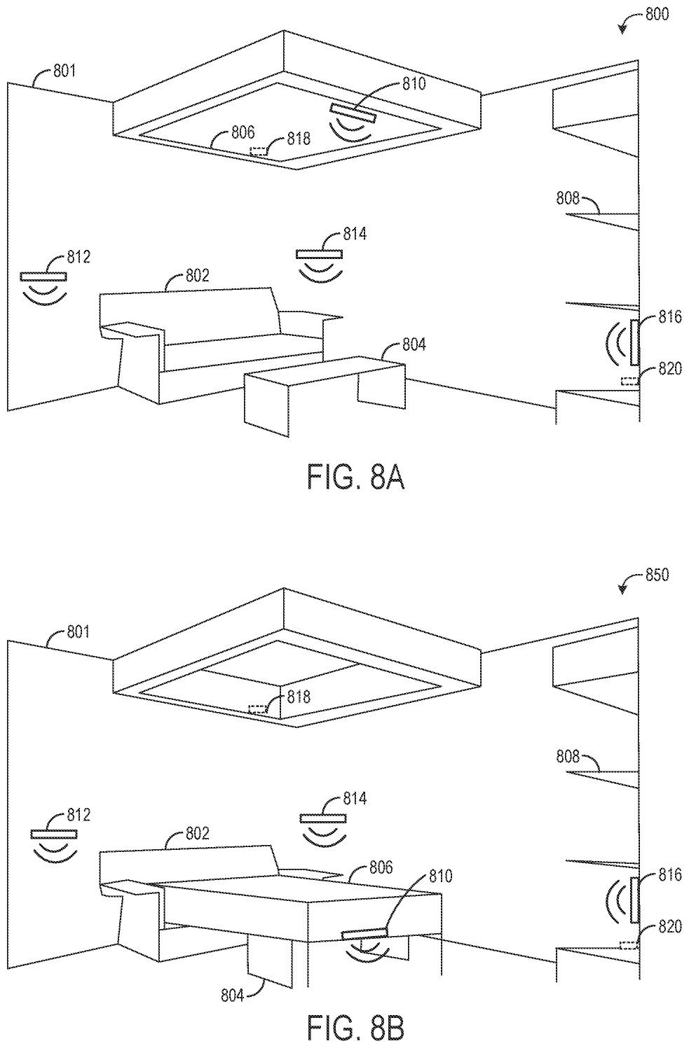

In one of many exemplary embodiments, the audio system described herein may generate an audio experience tailored to the listener or listeners when the system is configured in one of a plurality of use modes. As one example, in the use mode, the locations of the speakers are known, even though they may change when integrated into moving architecture components, the most typical or common locations of the occupants and their ears may change from mode to mode, and modal resonance frequencies of the room change as the architecture is transformed from one mode to another. Since all of these factors are known for the use mode, the speaker selection and equalization (also herein EQ) may be modified for the use mode to enhance the listening experience. FIG. 1 shows an example movable architecture. A flow chart illustrating an example method 200 for controlling an audio system for a room having movable architecture is shown in FIG. 2. The method 200 includes receiving one or more signals indicating a position of the movable architecture and optionally, the presence of listeners (203), adjusting tuning parameters of the audio system based on the received signals (206), and generating an audio output (208). The method for an audio system may include referencing a look-up table with predetermined parameters for adjusting the EQ, which includes frequency dependent magnitude, phase, delay, and so on, for one or more speakers of the audio system based on the use mode and on other signals. An example look-up table 300 is shown in FIG. 3. Example illustrations of some example use modes that audio system 100 may transform into are shown in FIG. 4, FIG. 5, FIG. 6, FIG. 7, FIG. 8A, and FIG. 8B.

FIG. 1 shows a schematic diagram of a movable architecture herein referred to as audio system 100. The audio system 100 includes a plurality of speakers mounted in the room, a plurality of EQ blocks, one or more audio input sources such as a receiver for music or other audio sources, and a control system in electronic communication with the speakers, the EQ blocks, the receiver, and the movable architecture and its controls. In one example, an occupant 190 may select from a plurality of use modes to transform movable room-defining components and storable furniture into different arrangements to allow for different types of activities and corresponding audio experiences. The schematic diagram illustrates a plan view.

Audio system 100 includes a fixed boundary 101 and a plurality of movable room-defining components. In the example, fixed boundary 101 comprises four walls including first boundary wall 132, second boundary wall 134, third boundary wall 136, and fourth boundary wall 138. In one example, the fixed boundary may comprise a plurality of fixed room-defining components. The fixed boundary 101 contains (e.g., surrounds, encloses) movable room-defining components including a movable wall unit 104. The movable wall unit 104 comprises four walls that move as a unit including first movable wall 140, second movable wall 142, third movable wall 144, and fourth movable wall 145. In one example, transformable furniture may store in the movable wall unit 104. Movable wall unit 104 is shown having flat walls; however, it may be understood that movable wall unit 104 may include shelves for storage, cabinets, closets, and so on. In various embodiments, movable wall unit 104 may extend to touch or nearly touch the ceiling of the room, or it may also be shorter. In an embodiment, the audio system 100 includes a stationary wall unit or fixed interior wall 146.

Audio system 100 includes a plurality of speakers and a plurality of equalizer (EQ) blocks. Audio system 100 includes one or more external input or audio input sources including receiver 160. In the example, speakers and EQ blocks are positioned throughout audio system 100 and are grouped by living areas. In one example, living areas may include one or more fixed speakers and one or more movable speakers. Speakers may be completely or partially housed in the plurality of movable room-defining components, such as movable walls. Speakers may also be completely or partially housed in the plurality of fixed room-defining components, such as fixed walls, e.g., boundary walls. In the example, a first area 102 comprises the living space having a perimeter defined by the first boundary wall 132 between the second boundary wall 134 and the first movable wall 140. The first area 102 includes a pair of fixed speakers 102a positioned on the second boundary wall 134. The first area 102 includes a pair of movable speakers 102b positioned on the first movable wall 140. The first area 102 includes one or more EQ blocks 102c. In the example, a second area 106 comprises the living space having a perimeter defined by the first boundary wall 132 between the third boundary wall 136 and the second movable wall 142, and door 148. The second area 106 includes a pair of fixed speakers 106a positioned on the third boundary wall 136. The second area includes a pair of movable speakers 106b positioned on the second movable wall 142. The second area 106 includes one or more EQ blocks 106c. In the example, a third area 116 comprises the living space having a perimeter defined by the third boundary wall 136 between the fourth boundary wall 138 and the fixed interior wall 146. The third area 116 includes a group of fixed speakers 116a positioned on the fixed interior wall 146 and positioned on the fourth boundary wall 138. The third area 116 includes movable speakers 116b positioned on a movable bed unit 120. The third area 116 includes one or more EQ blocks 116c.

Speakers of audio system 100 may include speaker arrays. For example, the pair of fixed speakers 102a may include an array of speakers that are optionally paired with an array of EQs. Speakers of the audio system 100 may include a variety of speaker types. For example, speakers may include any of loudspeakers, multi-way loudspeakers, subwoofers, woofers, mid-range speakers, tweeters, horns, and so on. Speakers can be housed partially or entirely in core components, such as the movable and fixed walls, as well as in movable furniture (e.g., movable speakers 116b). In one example, speakers, EQ blocks, and audio input sources of audio system 100 may be in wired or wireless electronic communication with a control system 150. In another example, some speakers, EQ blocks, and audio input sources may be wired and some may be wireless. In one example, wireless speakers of the audio system 100 may be Bluetooth® enabled. (Bluetooth® is a registered trademark of Bluetooth SIG, Inc., Kirkland, WA.). In another example, a constellation of one or more wireless speakers may be included, in addition to the in-wall speaker embodiments. In some examples, a wireless speaker or speakers can dock in the movable wall unit 104, or the fixed interior wall 146, or in or on other modules during music playback or for recharging. The wireless speakers can then be detached and moved around the room or can be taken outside the room and used as wireless speakers on the go.

The exact location of the EQ blocks and audio amplifiers may vary in the system. As a few examples, the EQ block and/or amplifier may be physically located in the speaker housing (e.g. 106a), in a separate, dedicated housing (e.g. 102c), in a receiver (e.g. 160), in a separate, dedicated amplifier. An EQ block can be located in a software application (e.g. running in processor 152 or elsewhere), in a control panel accessed with a GUI (e.g. driven by a user interface 156), or it can even be applied in the cloud, in the case of a software application controlled system. Audio system 100 may include a combination of EQ block locations and audio amplifier locations. The number and arrangement of speakers, audio inputs, and EQ blocks in audio system 100 are exemplary in nature and additional or alternative numbers and arrangements of audio system components may be included in some examples. In an embodiment, a simple system contains four or fewer speakers, while a more complex system may contain sixteen speakers or more.

The first area 102, second area 106, and third area 116 of the audio system 100 are transformable living spaces providing one or more use modes corresponding to different use cases, tasks, or locations of the occupant 190. In one example, the audio system 100 generates an audio experience for the use mode using a predetermined tuning parameter set matching an architecture configuration signal, which is described in more detail to follow. In one example, movable components such as transformable furniture may be moved into and out from areas of the movable or fixed architecture. In one example, the first area 102 comprises a table 108, a movable bench or bench 110, a couch 112, a chair 114, and a window shade 118. The table 108, the bench 110, and the window shade 118 may be transformable furniture. For example, the table 108 may move in the direction indicated by an arrow 128 to provide a desk, a table, or to selectively store inside the movable wall unit 104. Similarly, the bench 110 may be stored inside the movable wall unit 104 (as shown) and may move in the direction indicted by arrow 130 to selectively provide seating in first area 102. In one example, the window shade 118 may be used as a projector screen. In one example, when using the window shade 118 for projection, a left-right orientation of speakers of the first area 102 may be automatically or manually re-configured.

Movable wall unit 104 including pair of speakers 102b and pair of speakers 106b positioned therein may selectively move in the direction indicated by arrow 124. In one example, the movable wall unit 104 may be commanded to move rightward. A rightward move increases the floor space between the fixed speakers 102a and the movable speakers 102b in the first area 102 and decreases the floor space between the fixed speakers 106a and the movable speakers 106b in the second area 106. In another example, the movable wall unit 104 may be commanded to move leftward, increasing the area in second area 106. In such an example, the floor space between the fixed speakers 106a and the movable speakers 106b in the second area 106 increases and the floor space between the fixed speakers 102a and the movable speakers 102b in the first area 102 decreases. In one example, the second area 106 selectively transforms from a larger bathroom and dressing area to a smaller bathroom depending on the configuration of the movable wall unit 104. In one example, the door 148 opens and closes in the direction of arrow 126. In some examples, door 148 is omitted. In an embodiment, movable wall unit 104 can be moved to the right resulting the second area 106 shrinking to any size, even to the extent that it shrinks to zero and is not occupiable. In an embodiment, movable wall unit 104 is moved to the left any amount, even including when area 102 shrinks to be unoccupiable. In various embodiments, movable wall unit 104 can move in other or multiple directions, has an alternate shape, and/or includes no or other transformable furniture.

In one example, the third area 116 comprises the movable bed unit 120 and a second couch 122. The movable bed unit 120 and the second couch 122 may be transformable furniture. For example, the movable bed unit 120 may be commanded to selectively raise into at least a portion of a movable ceiling for storage and descend for sleeping or sitting. In other words, the movable bed unit 120 converts into at least a portion of the ceiling. In other examples, a movable bed unit may selectively store in at least a portion of a wall. With the movable bed unit 120 stored, the second couch 122 provides a sitting area. The movable speakers 116b may be positioned in the movable bed unit 120, such that with the bed stored, the speakers are positioned in proximity to the ceiling, for example, over the head of the occupant 190 while seated on the second couch 122.

In one example, one of a plurality of use modes may be selected by the occupant 190 to configure an arrangement of the movable room-defining components, such as the position of the movable walls and the speakers positioned therein and the transformable furniture. Some examples include a first mode such as morning mode, a second mode such as an office (or work) mode, a third mode such as a dinner party mode, and fourth mode such as an entertaining mode. Additional modes may include the movable bed unit 120 and second couch 122 configured for sleeping versus sitting. In one example, in response to receiving a signal indicating the position of the movable components of the rooms, such as indicated by the use mode, the audio system 100 modifies its settings by activating one or more speakers and adjusting or selecting tuning parameters of the speakers for a listening experience tailored to the particular acoustic environment created by that arrangement of the movable components of the room. Additionally, signals such as the presence of the occupant 190 and other listeners may be received by the control system 150 and the audio system settings modified in response thereto. Moreover, the occupant 190 may desire different audio environments based on the selected use mode. See FIGS. 4-8B for illustrations showing some example use modes that audio system 100.

The control system 150 may include one or more processors including processor 152. The processor 152 may execute and control operations of the audio system 100. For example, the processor 152 may generate sweep signals, and determine new impulse response (IR) and EQ data for each use mode and/or room configuration and/or occupant location. A memory 154 may be included in the control system 150 to store data such as instructions executable by processor 152. Memory 154 may store application data to enable the control system 150 to run an application for connecting to a cloud-based server and/or collecting information for transmission to the cloud-based server. Memory 154 may include a volatile memory, e.g., random access memory (RAM). Memory 154 may include non-transitory storage devices storing instructions and/or code that, when executed by processor 152, controls audio system 100 to perform one or more of the methods described in the disclosure. For example, memory 154 may store one or methods for adjusting one or more tuning parameters of the speakers of the audio system 100, described in more detail in FIG. 2. For example, memory 154 may retrieve EQ data for the speakers of the system based on received sensor signals indicating room configuration and/or listener location. In one example, the memory 154 may retrieve EQ data from a look-up table, described in more detail in FIG. 3.

A user interface 156 may be included in the control system 150. User interface 156 may include a graphical user interface presented on a touch screen, display screen, or user-actuated buttons, switches, knobs, dials, sliders, and so on. The control system 150 may also interact with a mobile device via user interface 156. Occupant preferences/information and/or responses to presented messages may be performed via user input to the user interface 156. In one example, the control system 150 is in electronic communication with an architecture configuration signal generator 162. The architecture configuration signal generator 162 may provide a signal to the control system 150 indicating the room configuration such as the use mode. As one example, the use mode may be input via the user interface 156 and transmitted to the architecture configuration signal generator 162. The selection may be received by the control system 150. Based on the received architecture configuration signal, the control system 150 may command to reconfigure the architecture and load the predetermined EQ and other tuning parameters associated with the new acoustic environment. As another example, a wall mounted switch, remote control, mobile or other application, machine vision, or other sensors may generate an architecture configuration signal. The control system 150 may retrieve information gathered by various sensors 158, user interface 156, architecture configuration signal generator 162, receiver 160, data stored in memory 154, devices in communication with the audio system 100 (e.g., a mobile device connected via a wired or wireless connection such as a Bluetooth® link), and so on. Moveable architecture components may contain a sensor or a simple limit switch(s) to indicate their position, thereby providing a signal to the architecture configuration signal generator 162 (e.g. table 108, movable wall unit 104, bench 110, window shade 118 may have sensors to indicate their position, and hence an indicator of the room configuration)

Sensors 158 of audio system 100 may include a plurality of auxiliary sensors. Some examples include microphones, passive or active infrared (IR) proximity sensors, image sensors, machine vision sensors, clocks, or other time keeping devices to measure the time of day, and others. As one example, microphones may be included in audio system 100 to receive voice commands from the occupant 190 or other users, to measure ambient noise in the room, to determine whether audio from speakers of the room is tuned in accordance with an acoustic environment of the room, to measure an impulse response from one or multiple speakers to a listening or location so-as to derive and store a speaker EQ curve or curves, and so on. A wired or wireless microphone sensor may also be movable by the user in order to measure and store an impulse response (e.g. to derive a new speaker EQ curve) at a new listening location, or in a new reconfigurable architecture configuration. In one example, IR sensors or image sensors using machine imaging may signal presence and/or position of a listener, e.g., occupant 190, in a first area 102. Similarly, a mobile device may generate a signal indicating a presence of one or more listeners. One or more sensors 170 may be located in the first area 102 such as a microphone. The first area 102 may also include a sensor 168, e.g., a proximity sensor, positioned on chair 114 for signaling a location of the chair 114 and/or person in the chair. The second area 106 may include one or more sensors 166 such as a contact sensor positioned on door 148 for signaling a closed or open status of the door 148. One or more sensors 172 such as proximity sensors, imagers, and a microphone may be positioned in third area 116 for signaling a location of one or more listeners, room acoustics, etc.

FIG. 2 is a flow chart of a method 200 for modifying audio system operation based on a configuration of a movable architecture, such as an arrangement of one or more rooms of a living space. For example, method 200 may be performed by control system 150 to modify the audio system configuration of audio system 100 of FIG. 1.

At 202, the method includes receiving an architecture configuration signal. In one example, the architecture configuration signal may include one or more of a room configuration signal. For example, an origin of the room configuration signal may include a wall mounted switch, a remote control, a mobile or other device application, a machine vision sensor, an image sensor, proximity sensor or other sensors. Some examples are shown in audio system 100, including architecture configuration signal generator 162 and the sensors, e.g., sensors 158, 166, 168, etc., positioned variously throughout the rooms.

In one example, the architecture configuration signal may indicate a use mode selected by the user. For example, for a selected use mode, the geometry of the room, the speaker location, position of movable and fixed components such as movable walls, storable furniture, listener preferences, etc. may be known.

At 203, the method includes an optional step of receiving a listener location signal. In one example, the listener location signal may originate from a mobile device, from a machine vision sensor, from an image sensor, from a passive or active IR sensor, from a proximity sensor and/or from a seat, couch, chair, bed mounted load sensor or other sensor types able to output a signal from which an occupant location can be derived. In an embodiment, sensors and associated processing can be used to determine if multiple listeners are present within the listening spaces (e.g. 102, 106, and 116). In an embodiment, the locations of some or all of the multiple listeners can be determined in the listening spaces such that an associated set of predetermined audio system tuning parameters can be selected for audio system 100 to improve their listening experience. In an embodiment, the exact head location, or even the exact ear canal opening locations of a listener or listeners can be determined for the selection of audio system tuning parameters. Therefore, in various embodiments, listener location can be a course estimate, such as “in listening space 102”, a finer estimate, such as the location such as “on the couch” or “on the desk chair”, a fairly specific location such as a position to within 30 cm in 2 dimensions or 3 dimensions, or an exact location of a listeners head or ear canal opening(s) in 3 dimensions specified to within 5 cm or less.

At 204, the method determines if the room configuration has changed or optionally, that the listener location has changed. In one example, the room configuration, such as the use mode, may be stored as a flag in the memory of the control system and the method includes checking the flag to determine if the room configuration has changed. Similarly, the listener location may be stored as flag and the method includes checking the flag to determine if the listener location has changed. For example, such a location estimate may be derived from signals received from a sensor indicating a listener position or a closed door, or stored in the memory of the control system. If the room configuration or listener location has not changed, the method returns to receiving the architecture configuration signal at 202. If the room configuration or the listener location has changed, the method continues to 206.

At 206, the method includes modifying the audio system configuration with predetermined tuning parameters. For example, the method may include inputting the received architecture configuration signal into a look-up table, which is described in more detail with respect to FIG. 3 and following figures. As one example, the use mode may be input into a look-up table and stored audio settings such as EQ, gain, and other tuning parameter modifications provided as the output. For the use mode, the predetermined audio settings (e.g., optimized settings, preferred settings) may be stored in the memory of the control system, the settings based on information such as the known position of the movable components, the room geometry, and the location of the speakers in the room. In another example, sensor signals may be input into the look-up table. For example, the presence or location of one or more listeners may be input, and modifications to the audio settings provided in response. Modifying the audio system configuration with predetermined parameters may include adjusting EQ of one or more speakers to modify their frequency or phase response and/or delay, deactivating one or more speakers, or limiting a frequency range such as liming to a low frequency range. In one example, the control system may transmit the updated audio settings to the one or more EQ blocks in the audio system.

In one example, a gradual transition between audio modes is possible, and may be desired in cases such as when an occupant seated at table 108 stands and moves to a different listening area. In cases such as this, speaker amplitudes can be ramped up or down to achieve their new settings, EQ's can be cross-faded between or in some functionally equivalent manner be transitioned elegantly between the previous look-up table values and the new look-up table values.

At 208, the method includes generating an audio signal using the predetermined parameters. In some examples, tuning parameters may be determined based on a room simulation performed in a cloud network in communication with the audio system. Simulation may be performed at the time of configuration or later to populate a list of predetermined tuning parameters. As another example, acoustic measurements may be made during installation. Methods to derive a list of predetermined tuning parameters such as an equalization curve to achieve a target frequency response are known to those of ordinary skill in the art. An example of these methods includes sending a noise or sweep signal to a speaker and measuring the sound at a microphone position that may optionally be a target listener location to determine an impulse response or transfer function, and forming a frequency dependent EQ and delay curve based on the difference between this measurement and a predetermined target. Other functionally equivalent methods are possible. In another aspect, if predetermined tuning parameters are not stored, one or more of the components (e.g., movable walls, fixed walls, speakers positioned therein, furniture, etc.) of the audio system may contain a microphone, and the re-configuration of the room can trigger a measurement of the system frequency response for audio optimization of that mode. For example, the method may include measuring target EQ settings in response to an indication of room re-configuration based on acoustic measurements via the microphone and audible and sub-audible impulse response measurement.

From 208, the method returns to 202 to continuously monitor architecture configuration. The sensors can output an updated listener location at a rate from once per system usage, to once per second or even faster in order to capture events such as a rotation of the listeners head. Thus, the method 200 can be repeated at any of a wide range of rates, including predetermined rates, or whenever an updated room configuration or listener location signal has changed.

FIG. 3 shows an example look-up table 300 for a method for adjusting tuning parameters of an audio system for a room having movable architecture based on an architecture configuration signal. In one example, example look-up table 300 may be retrieved at 206 in the method 200 as described in FIG. 2, and the control system may modify the audio system configuration based on the predetermined tuning parameters or audio settings stored in the look-up table. As illustrated in look-up table 300, the use mode and one or more auxiliary sensor signals may be input and audio settings for one or more speakers of the audio system may be output. For reference, look-up table 300 is shown as a two-dimensional table. In other embodiments, the method may include one or more multi-dimensional look-up tables.

In the example, look-up table 300 stores audio settings for use modes including a morning mode, an office or work mode, a dinner party mode, and an entertainment mode. The settings are further differentiated based on area of the living space (e.g., a room) and speaker position. For example, area includes a first area, a second area, and a third area. In one example, the first area may be the same or similar to first area 102, the second area may be the same or similar to second area 106, and the third area may be the same or similar to third area 116 described with respect to FIG. 1. Speaker position includes fixed speakers and movable speakers positioned in the respective area such as the fixed speakers 102a and movable speakers 102b in first area 102. In one example, the audio settings are given for the groups of fixed speakers and movable speakers. In some modes, fixed and movable speakers in an area adjusted differently, and in other modes, they may be adjusted similarly. In some modes, some speakers are active and some speakers are deactivated. For example, in a first mode a first set of speakers are active, and in a second mode, a second set of speakers are active, and so on. Any of the many methods to deactivate a speaker are possible, for example a speaker may be deactivated by turning off power to amplifier, disconnecting a speaker wire with relay, having its amplifier or speaker input signal converted to zeros, or by setting a channel gain to zero or to a negligible level, etc. In other examples of the method, a look-up table may store audio settings for individual speakers. Audio settings are further differentiated based on whether one or more auxiliary sensor signal is received. Auxiliary sensor signals may be various, including and not limited to, sensors indicating a position of one or more listeners (e.g., occupant 190), signals indicating a mode of use of the transformable architecture or furniture, and open/closed status of doors.

The table output, or the predetermined parameters for modifying the audio system, includes EQ setting, a volume level or amplitude, sound field control such as uniform, diffuse, or hot spot minimizing, phase alignment, and time alignment. In one example, the stored audio settings in look-up table 300 may be optimized to factors such as the modal resonance frequencies of the room, the task or activity of the listener, the position of the listener's ears, listener preferences, and so on. In one example, the EQ setting may include adjustments to frequency-dependent equalization to accommodate an increased listening area size (e.g. 102). EQ settings are SET 1 for first setting, SET 2 for second setting, UNI 1 for first uniform setting, and UNI2 for second uniform setting. Similar EQ setting names for different speaker positions is not meant to imply similar tuning parameters. For example, the particular frequency equalization adjustments for the speakers in any given mode may be different from speaker to speaker and area to area. In one example, the volume level setting may include volume level adjustment to suit tasks or preferences corresponding to the use mode. In another example, volume level may be adjusted to compensate for speaker position. The volume level or amplitude settings are OFF, LOW, and MID. Time alignment among two or more speakers may be stored for one or more modes. Examples given in look-up table 300 include cross-talk canceling for imaging enhancement and beam forming for directivity control.

To take a first example from look-up table 300, in the morning mode and responsive to an auxiliary sensor signal, such as indicating a time of day or a position of the occupant, a first set of speakers may be activated and some of the speakers of the architecture configuration may be deactivated. For example, fixed and movable speakers in the first area and the third area may be powered off. In the second area, fixed speakers may be adjusted to a first EQ setting at a mid-level volume. The tuning parameters of the movable speakers in the second area may be adjusted to the first EQ setting at a mid-level volume, with cross-talk cancellation for one or more pairs of speakers where the position of the occupant may be known.

To take a second example from look-up table 300, in the dinner party mode and responsive to an auxiliary sensor signal, such as indicating listeners are positioned throughout the living space (e.g., auxiliary sensor N), the tuning parameters of the fixed and movable speakers in the first area and the third area may be adjusted to a first uniform EQ setting at a mid-level volume. Fixed and movable speakers in the second area may be adjusted to a second EQ setting at a mid-level volume. For example, the second EQ setting may include adjustments to compensate for the smaller room size. In one example, speaker selection in the dinner party mode may include activating some of the speakers in the first area and in the third area that were not active in the morning mode.

Example illustrations of some example use modes that audio system 100 may transform into are shown in FIG. 4, FIG. 5, FIG. 6, FIG. 7, FIG. 8A, and FIG. 8B. In one example, an audio experience may be generated for the use mode according to methods that may be the same or similar to method 200 in FIG. 2 and look-up table 300 in FIG. 3. The audio system 100 shown in following example use mode configurations may include the same or similar components as described with respect to FIG. 1 and may not all be reintroduced.

FIG. 4 shows a first mode 400 for audio system 100. In one example, the first mode may be a morning mode having a first configuration of movable room-defining components of audio system 100. The movable wall unit 104 is adjusted leftward in the direction of arrow 124, increasing the floor space in second area 106, e.g., the bathroom, and reducing the floor space in first area 102. The table 108 and the bench 110 are stored in the movable wall unit 104. In third area 116, the movable bed unit 120 may be stored or on the floor. Based on the position of the movable components and speakers positioned therein, on the occupant location, in addition to tasks of the occupant and other preferences, tuning parameters such as the speaker EQ, amplitude or volume level, gain, and other audio settings may be adjusted for audio system 100 for generating a tailored audio experience in the morning mode.

In one example, tuning parameters such as delay and frequency dependent EQ for the speakers in second area 106 may compensate for increased size of the room, the increased distance between movable speakers 106b and fixed speakers 106a. Similarly, tuning parameters for the speakers for first area 102 may compensate for decreased size of the room, the decreased distance between movable speakers 102b and fixed speakers 102a, the fact that the room may not be occupiable if the movable wall unit 104 is moved to within 1 meter or less of the second boundary wall 134, and the stored furniture. Tuning parameters for the speakers in third area 116 may factor in whether the movable bed unit 120 is stored or not stored. In another example, predetermined parameters for the audio system 100 configured in the morning mode may factor in auxiliary sensor signals. For example, sensor 166 may signal the door 148 is open or closed, and audio settings configured responsive to the signal setting.

In an exemplary audio experience in the morning mode, a first set of speakers may be activated to produce sound in a single area of the audio system 100. For example, audio may be generated in the second area 106, the bathroom and dressing area, and not generated in the first area 102 or the third area 116. The tuning parameter set for the speakers of audio system 100 in morning mode is stored in the look-up table 300. For the example, the auxiliary sensor referenced in look-up table 300 may be the sensor 166 detecting a status of door 148. If the sensor signals a closed door (e.g., Y, yes), a first set of audio settings are output for the audio system 100. If the sensor signals an open door (e.g., N, no), a second set of audio settings are output.

In one example, in the morning mode with door 148 closed, the fixed speakers 102a and movable speakers 102b may be deactivated. Similarly, the fixed speakers 116a and the movable speakers 116b may be deactivated. The closed position of the door may be read as an indication that occupant 190 is in second area 106, and therefore audio throughout the living space may not be desired. Speakers in the second area 106 may be activated. The audio settings for the fixed speakers 106a may include a first EQ setting, mid-level amplitude, and no phase or timing alignment. The audio settings for the movable speakers 106b may include the first EQ setting, which may be different from the first EQ setting for the fixed speakers 106a, mid-level volume, and cross-talk cancelling for a pair of speakers on opposing sides of a dressing mirror. In the morning mode with door 148 open, the occupant 190 may be determined to be moving about the living space, and therefore audio may be desired throughout. The audio settings for the fixed speakers and the movable speakers throughout audio system 100 may include the first EQ setting, low-level amplitude, and no phase or timing alignment.

Turning now to FIG. 5, in another example, an audio experience may be generated for a second mode 500. In one example, the second mode may be an office mode having a second configuration of movable room-defining components of audio system 100. The movable wall unit 104 and movable speakers positioned therein, e.g., 102b, 106b, are adjusted rightward in the direction of arrow 124, increasing the floor space in first area 102, e.g., the office, and reducing the floor space in second area 106. The table 108 is in a desk position in first area 102. In third area 116, the movable bed unit 120 is stored and the second couch 122 is usable. Based on the position of the movable components, the speaker locations, and the tasks of the occupant, the audio settings may be adjusted for audio system 100 for generating a tailored audio experience in the office mode.

In an exemplary audio experience, in the office mode, the position of the occupant 190 is known. Based on the position of the occupant 190, left and right fixed speakers 102a and movable speakers 102b can be configured properly. Additionally, a cross-talk canceller can be used to create a widened spatial image and beam forming may be used to direct sound to the occupant 190. For example, movable speakers 102b and/or fixed speakers 102a at ear level may be adjusted with phase alignment or time alignment. In one example, woofers or subwoofers may be contained within the movable wall unit 104. As such, the bass may be equalized to compensate for the new position of the woofers, and the extent to which the woofers excite the low frequency modes in the room changes due to the position of movable architecture elements (e.g. 104 and 120). In a more complex embodiment, a presence sensor, e.g., sensors 168, can be used to determine if the occupant is actually sitting at the table 108 for the audio system mode to engage. For example, the chair location may be determined from the presence sensor output or a chair-based sensor indicating the chair is occupied.

In one example, if the occupant 190 is in the chair 114, e.g., as indicated by one or more sensors or the use mode, the fixed speakers 106a, 116a and movable speakers 106b, 116b in the second area 106 and third area 116, respectively, may be deactivated, for example, because the position of the occupant is known to be in the first area 102, e.g., the office. In one example, a second set of speakers may be active, different from the first set of speakers, such as speakers in area 102. For example, speaker selection in the office mode may include activating some of the plurality of fixed and movable speakers in the first area 102 that were not active in the morning mode. The audio settings for the fixed speakers 102a and the movable speakers 102b may be adjusted to a second EQ setting, which may be different from the first EQ setting described with respect to the first mode. The second EQ setting may include adjustment of frequency equalization to compensate for the new room shape and furniture positioned therein. The setting may include EQ to achieve a target frequency response in a target region, such as the table 108. In one example, if the occupant 190 is not in the chair 114, such as indicated by a sensor or other input, audio settings for the audio system 100 in the office mode may be configured differently. For example, the audio system may be adjusted to generate low-volume, uniform sound throughout the living space, e.g., at fixed speakers 102a, 106a, 116a, and movable speakers 102b, 106b, 116b

Turning now to FIG. 6, in another example, an audio experience may be generated for a third mode 600. In one example, the third mode may be a dinner party mode having a third configuration of the movable room-defining components of audio system 100. The movable wall unit 104 and movable speakers positioned therein e.g., 102b, 106b, remain in the same position as in the second mode 500. The table 108 and bench 110 are adjusted leftward in the direction of arrow 124 and arrow 130, respectively. In third area 116, the movable bed unit 120 is stored and the second couch 122 is usable. Based on the position of the movable components, the speaker locations, and the tasks of the occupant, the audio settings may be adjusted for audio system 100 for generating a tailored audio experience in the dinner party mode.

In an exemplary audio experience, in the dinner party mode, a diffuse sound field can be created, such that the sound everywhere is approximately equal. This may involve the deactivation, or attenuation, of speakers that are not ideal for the dinner party mode. For example, the movable speakers 102b at ear level speakers that play in the office mode may be de-activated in the dinner party mode. In a more complex embodiment, a presence sensor, e.g., sensors 168, 170, can be used to determine if one or more listeners are actually sitting at the table 108 for the dinner party mode to engage. A uniform sound field will eliminate the problematic situation where some people are sitting too close to the speakers and cannot easily hear each other. If speaker arrays are used, the array coefficients can be reconfigured to direct sound away from the angles that are occupant locations.

In one example, if the occupant 190 and/or one or more listeners are detected at the table 108, e.g., as indicated by one or more sensors or indicated by the use mode, the movable speakers 102b may be powered off. In one example, the dinner party mode may include a third set of tuning parameters for a third set of speakers. For example, the fixed speakers 102a, 106a, 116a and movable speakers 106b, 116b may be set to a third EQ setting, such as uniform or diffuse setting, and including amplitude change for one or more of the speakers. Additionally, the EQ setting for the fixed speakers 102a, e.g., in proximity of the table 108, may take the form of a cross-talk canceller as the exact positions of one or more of the listeners are known. In one example, if listeners are sensed in other areas, such as in third area 116, while in the dinner party mode, one or more tuning parameters for one or more speakers of audio system 100 may be adjusted. For example, EQ may be adjusted to compensate for ambient noise or for known positions of listeners.

Turning now to FIG. 7, in another example, an audio experience may be generated for a fourth mode 700. In one example, the fourth mode may be an entertaining mode or multi-media mode configuration having movable components of audio system 100 configured as follows. The movable wall unit 104 and movable speakers positioned therein e.g., 102b, 106b, remain in the same position as in the second mode 500. The table 108 and bench 110 are stored in the movable wall unit 104. The window shade 118 is used as a projector screen and the couch 112 is reoriented to face the window shade 118. In third area 116, the movable bed unit 120 is stored and the second couch 122 is usable. Based on the position of the movable components, the speaker locations, and the tasks of the occupant, the audio settings may be adjusted for audio system 100 for generating a tailored audio experience in the entertainment mode.

In an exemplary audio experience, in entertainment mode, the right and left audio channels may be switched from their orientation in office mode (e.g., the second mode 500) if the window shade 118 is used as a projector screen. In such an example, the front, e.g., with respect to a position of the occupant 190, of the multi-media mode may be the rear in office mode. As such, the main speakers are 102a and the rear surround speakers are 102b in multi-media entertainment mode. Based on the inputs from the selected setting, appropriate audio EQ and channel mapping can all occur automatically as the audio system 100 is reconfigured into the multi-media mode. For example, EQ adjustments for the fixed speakers 102a and movable speakers 102b may consist of phase or time alignment between speakers arranged on opposite ends of the couch 112. In a more complex embodiment, a presence sensor, e.g., sensors 168, 170, may be used to determine if one or more listeners are actually sitting at on the couch 112 for the entertainment mode to engage. Other EQ settings may include adjusting speakers in third area 116 to produce a uniform sound field throughout the living area. In some examples, speakers in unused areas may be deactivated. In an embodiment, subwoofers located in other unused areas may be activated to improve or increase the bass response in the occupied areas. In an embodiment, additional speakers located on the ceiling above the occupied multi-media entertainment listening area may be activated, and EQ settings to route media content to them (e.g. Dolby Atmos height channels) will aide in delivering an immersive audio experience to the listeners.

FIG. 8A and FIG. 8B illustrate exemplary use modes for an audio system for a room having movable architecture. In one example, the fifth mode 800 shown in FIG. 8A and the sixth mode 850 shown in FIG. 8B may be included in audio system 100. For example, wall 801 may be the same or similar to fixed interior wall 146, couch 802 may be the same or similar to the second couch 122, and movable bed unit 806 may be the same or similar to movable bed unit 120. The audio equipment included in the fifth mode 800 and the sixth mode 850 may be in electronic communication with a control system, such as the control system 150 described with respect to FIG. 1. For example, fixed speakers 812, 814 mounted to wall 801, detachable speakers 816 selectively mounted to shelf 808, and movable speakers 810 mounted to movable bed unit 120, may be in wired or wireless communication with the control system 150.

Turning first to FIG. 8A, the fifth mode includes movable bed unit 806 in a stored position, overhead as a movable ceiling. The couch 802 and the table 804 are available for use. In one example, in the fifth mode, the location of one or more listeners, including orientation may be known by the orientation of the couch. For example, left and right for fixed speakers 812, 814 may be configured and EQ may consist of phasing or time alignment targeted to the listener. Similarly, the location of the listener may be factored into the EQ for the detachable speakers 816. For example, the audio system 100 may detect when the detachable speakers are mounted to the shelf 808. In response, an EQ setting may be adjusted correspondingly. Just as sensor output signals can be used to determine the location of listeners, they can also be used to determine the location of the detachable speakers. Since the location of detachable speakers can be known, the appropriate EQ for any given location can be computed and stored for later use using various aforementioned techniques. Movable speakers 810 are overhead when the bed is stored. In one example, the movable speakers 810 may be limited in frequency range when overhead such as set to provide a limited frequency, e.g., bass, as may be preferred if the speakers are full range speakers and high frequencies coming from the ceiling are undesirable. EQ adjustments for the fifth mode may also include speaker selection and volume level tailored to the task or preferences of the listener. In some examples, signals from one or both of sensors 818 and sensors 820 may provide additional information about the desired audio experience. For example, one or more speakers may be adjusted for conversation based on a received signal.

Turning now to FIG. 8B, the sixth mode includes movable bed unit 806 positioned in the room. The couch 802 and the table 804 are not available for use. In one example, low frequency EQ may be adjusted for one or more speakers to accommodate the influence of the bed on the acoustic space. In another example, and similar to the fifth mode, the location of the one or more listeners, including orientation may be known by the orientation of the bed and left/right EQ may be adjusted correspondingly. Movable speakers 810 are lowered when the bed is available. In one example, when lowered, the movable speakers 810 may be equalized for a full range frequency response. EQ adjustments for the sixth mode may factor in the use mode, sensor signals, and user preferences. For example, in the sixth mode, adjustments may include reducing the volume level for one or more speakers or optimizing EQ to a preferred style of music.

In this way, an integral audio system may be automatically reconfigured to provide high-quality audio system performance for a room having movable architecture. For the user selected mode of use, the room walls, and other fixtures containing the audio system components shift into different arrangements to allow for different types of activities, including an audio experience tailored to the listener or listeners and the acoustic environment. By receiving the use mode, the locations of the speakers are known, even though they may be integrated into the moving surfaces or may be movable, the locations of the occupants are known, possibly including their relative orientation to the speakers, and the modal resonance frequencies of the room that change as the architecture transforms from one mode to another. Since all of these factors are known for each mode, the speaker selection and tuning parameters may be optimized for each use mode. The technical effect is increased enjoyment of the audio experience for a listener.

In another representation, a movable architecture, comprising: an architecture configuration having a one or more movable room-defining components; a plurality of speakers mounted to the architecture configuration; and a control system in electronic communication with the one or more movable room-defining components and the plurality of speakers, wherein the control system is configured to adjust one or more tuning parameters of one or more of the plurality of speakers based a position of the one or more movable room-defining components. The movable architecture of claim 1, wherein one or more of the plurality of speakers are mounted to the one or more movable room-defining components. The movable architecture of claim 1, wherein one or more of the plurality of speakers are mounted to one or more fixed room-defining components. The movable architecture of claim 1, wherein the control system is further configured to adjust the one or more tuning parameters of one or more of the plurality of speakers based on a use mode indicating the position of the one or more movable room-defining components. The movable architecture of claim 1, wherein the control system is further configured to adjust the one or more tuning parameters of one or more of the plurality of speakers based on a listener location. The movable architecture of claim 1, wherein the one or more tuning parameters include one or more of frequency-dependent equalization, amplitude, sound field control, deactivation, phase alignment, time alignment and cross-talk cancellation. The movable architecture of claim 1, wherein the plurality of speakers are adjusted based on a look-up table, an output of the look-up table including predetermined tuning parameters based on the position of the one or more movable room-defining components, a use mode, and an auxiliary sensor signal. The movable architecture of claim 1, wherein the plurality of speakers are one or more of in-wall speakers, speaker arrays, and detachable speakers. The movable architecture of claim 1, wherein the control system is further configured to measure target equalizer settings in response an indication of room, speaker, or occupant re-configuration. The movable architecture of claim 1, wherein the control system is further configured to determine tuning parameters based on a simulation of the architecture configuration, and wherein the one or more movable room-defining components include one or more of a movable wall, a movable ceiling, a movable bed that converts to at least a portion of a wall, a movable wall unit, a movable bed that converts to at least a portion of a ceiling, a movable table that selectively stores in the movable wall unit, a movable bench that selectively stores in the movable wall unit, and a window shade that converts to a projector screen.

The disclosure also provides support for an audio system for controlling and modifying an audio signal in a room having selectively reconfigurable architecture, the audio system comprising: a plurality of speakers mounted to an architecture configuration having one or more movable room-defining components, and a control system in electronic communication with the plurality of speakers and the one or more movable room-defining components, wherein the control system is configured to adjust one or more tuning parameters of one or more of the plurality of speakers based a position of the one or more movable room-defining components. In a first example of the system, one or more of the plurality of speakers are mounted to the one or more movable room-defining components. In a second example of the system, optionally including the first example, one or more of the plurality of speakers are mounted to one or more fixed room-defining components. In a third example of the system, optionally including one or both of the first and second examples, the control system is further configured to adjust the one or more tuning parameters of one or more of the plurality of speakers based on a use mode indicating the position of the one or more movable room-defining components. In a fourth example of the system, optionally including one or more or each of the first through third examples, the control system is further configured to adjust the one or more tuning parameters of one or more of the plurality of speakers based on a listener location. In a fifth example of the system, optionally including one or more or each of the first through fourth examples, the one or more tuning parameters include one or more of frequency-dependent equalization, gain, sound field control, deactivation, phase alignment, time alignment and cross-talk cancellation. In a sixth example of the system, optionally including one or more or each of the first through fifth examples, the plurality of speakers are adjusted based on a look-up table, an output of the look-up table including predetermined tuning parameters based on the position of the one or more movable room-defining components, a use mode, and an auxiliary sensor signal. In a seventh example of the system, optionally including one or more or each of the first through sixth examples, the plurality of speakers are one or more of in-wall speakers, speaker arrays, and detachable speakers. In an eighth example of the system, optionally including one or more or each of the first through seventh examples, the control system is further configured to measure target equalizer settings in response an indication of room, speaker, or occupant re-configuration. In a ninth example of the system, optionally including one or more or each of the first through eighth examples, the control system is further configured to determine tuning parameters based on a simulation of the architecture configuration, and wherein the one or more movable room-defining components include one or more of a movable wall, a movable ceiling, a movable bed that converts to at least a portion of a wall, a movable wall unit, a movable bed that converts to at least a portion of a ceiling, a movable table that selectively stores in the movable wall unit, a movable bench that selectively stores in the movable wall unit, and a window shade that converts to a projector screen.

The disclosure also provides support for a method for a movable architecture, comprising: receiving an architecture configuration signal, modifying one or more tuning parameters of an audio system based on the architecture configuration signal, and generating an audio output with the modified tuning parameters. In a first example of the method, one or more speakers move with the movable architecture and one or more speakers do not move with the movable architecture and tuning parameters are adjusted for the one or more speakers that move and the one or more speakers that do not move. In a second example of the method, optionally including the first example, the modifying includes adjusting one or more of frequency-dependent equalization, gain, sound field control, deactivation, phase alignment, time alignment and cross-talk cancellation for one or more speakers of the audio system. In a third example of the method, optionally including one or both of the first and second examples, the one or more tuning parameters are modified based on a look-up table, an output of the look-up table including predetermined tuning parameters based on one or more of a position of the movable architecture, an occupant location, a use mode, a speaker location, and an auxiliary sensor signal. In a fourth example of the method, optionally including one or more or each of the first through third examples, the architecture configuration signal includes one or more of a room configuration signal, and where the modifying is further based on a listener location signal.

The disclosure also provides support for a method for a movable architecture, the movable architecture comprising an architecture configuration having one or more movable room-defining components and fixed components, a plurality of speakers mounted to the architecture configuration, and a plurality of use modes, the method comprising: in a first mode where a movable wall unit and a movable table are in a first configuration, activating a first set of speakers, adjusting the first set of speakers to a first set of tuning parameters based on the first configuration of the movable wall unit and the movable table, and generating an audio output, and in a second mode where the movable wall unit and the movable table are in a second configuration, activating a second set of speakers, adjusting the second set of speakers to a second set of tuning parameters based on the second configuration of the movable wall unit and the movable table, and generating the audio output. In a first example of the method, the method further comprises: in a third mode where the movable wall unit and the movable table are in a third configuration, activating a third set of speakers, adjusting the third set of speakers to a third set of tuning parameters based on the third configuration of the movable wall unit and the movable table, and generating the audio output. In a second example of the method, optionally including the first example, the first set of speakers includes one or more fixed speakers and one or more movable speakers in a first area, the second set of speakers includes the one or more fixed speakers and the one or more movable speakers in a second area and does not include the one or more fixed speakers and the one or more movable speakers in in the first area, and the third set of speakers includes the one or more fixed speakers and the one or more movable speakers in a third area, and includes one or more of the speakers in the first area and one or more of the speakers in the second area. In a third example of the method, optionally including one or both of the first and second examples, the architecture configuration is one or more rooms of a living space. In a fourth example of the method, optionally including one or more or each of the first through third examples, the adjusting is further based on a listener location signal.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the audio system 100 and/or occupant 190 described with reference to FIG. 1, FIG. 4, FIG. 5, FIG. 6, FIG. 7, FIG. 8A, and FIG. 8B. The methods may be performed by executing stored instructions with one or more logic devices (e.g., processors) in combination with one or more additional hardware elements, such as storage devices, memory, hardware network interfaces/antennas, switches, actuators, clock circuits, etc. The described methods and associated actions may also be performed in various orders in addition to the order described in this application, in parallel, and/or simultaneously. An individual step may be omitted in a particular embodiment. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and preceded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. An audio system for controlling and modifying an audio signal in a room having selectively reconfigurable architecture, the audio system comprising:
a plurality of speakers mounted to an architecture configuration having one or more movable room-defining components; and
a control system in electronic communication with the plurality of speakers and the one or more movable room-defining components,
wherein the control system is configured to adjust one or more tuning parameters of one or more of the plurality of speakers based a position of the one or more movable room-defining components.

2. The audio system of claim 1, wherein one or more of the plurality of speakers are mounted to the one or more movable room-defining components.

3. The audio system of claim 1, wherein one or more of the plurality of speakers are mounted to one or more fixed room-defining components.

4. The audio system of claim 1, wherein the control system is further configured to adjust the one or more tuning parameters of one or more of the plurality of speakers based on a use mode indicating the position of the one or more movable room-defining components.

5. The audio system of claim 1, wherein the control system is further configured to adjust the one or more tuning parameters of one or more of the plurality of speakers based on a listener location.

6. The audio system of claim 1, wherein the one or more tuning parameters include one or more of frequency-dependent equalization, gain, sound field control, deactivation, phase alignment, time alignment and cross-talk cancellation.

7. The audio system of claim 1, wherein the plurality of speakers are adjusted based on a look-up table, an output of the look-up table including predetermined tuning parameters based on the position of the one or more movable room-defining components, a use mode, and an auxiliary sensor signal.

8. The audio system of claim 1, wherein the plurality of speakers are one or more of in-wall speakers, speaker arrays, and detachable speakers.

9. The audio system of claim 1, wherein the control system is further configured to measure target equalizer settings in response an indication of room, speaker, or occupant re-configuration.

10. The audio system of claim 1, wherein the control system is further configured to determine tuning parameters based on a simulation of the architecture configuration, and wherein the one or more movable room-defining components include one or more of a movable wall, a movable ceiling, a movable bed that converts to at least a portion of a wall, a movable wall unit, a movable bed that converts to at least a portion of a ceiling, a movable table that selectively stores in the movable wall unit, a movable bench that selectively stores in the movable wall unit, and a window shade that converts to a projector screen.

11. A method for a movable architecture, comprising:
receiving an architecture configuration signal;
modifying one or more tuning parameters of an audio system based on the architecture configuration signal; and
generating an audio output with the modified tuning parameters.

12. The method of claim 11, wherein one or more speakers move with the movable architecture and one or more speakers do not move with the movable architecture and tuning parameters are adjusted for the one or more speakers that move and the one or more speakers that do not move.

13. The method of claim 11, wherein the modifying includes adjusting one or more of frequency-dependent equalization, gain, sound field control, deactivation, phase alignment, time alignment and cross-talk cancellation for one or more speakers of the audio system.

14. The method of claim 11, wherein the one or more tuning parameters are modified based on a look-up table, an output of the look-up table including predetermined tuning parameters based on one or more of a position of the movable architecture, an occupant location, a use mode, a speaker location, and an auxiliary sensor signal.

15. The method of claim 11, wherein the architecture configuration signal includes one or more of a room configuration signal, and where the modifying is further based on a listener location signal.

16. A method for a movable architecture, the movable architecture comprising an architecture configuration having one or more movable room-defining components and fixed components, a plurality of speakers mounted to the architecture configuration, and a plurality of use modes, the method comprising:
in a first mode where a movable wall unit and a movable table are in a first configuration, activating a first set of speakers, adjusting the first set of speakers to a first set of tuning parameters based on the first configuration of the movable wall unit and the movable table, and generating an audio output; and
in a second mode where the movable wall unit and the movable table are in a second configuration, activating a second set of speakers, adjusting the second set of speakers to a second set of tuning parameters based on the second configuration of the movable wall unit and the movable table, and generating the audio output.

17. The method of claim 16 further comprising, in a third mode where the movable wall unit and the movable table are in a third configuration, activating a third set of speakers, adjusting the third set of speakers to a third set of tuning parameters based on the third configuration of the movable wall unit and the movable table, and generating the audio output.

18. The method of claim 17, wherein the first set of speakers includes one or more fixed speakers and one or more movable speakers in a first area, the second set of speakers includes the one or more fixed speakers and the one or more movable speakers in a second area and does not include the one or more fixed speakers and the one or more movable speakers in in the first area, and the third set of speakers includes the one or more fixed speakers and the one or more movable speakers in a third area, and includes one or more of the speakers in the first area and one or more of the speakers in the second area.

19. The method of claim 16, wherein the architecture configuration is one or more rooms of a living space.

20. The method of claim 16, wherein the adjusting is further based on a listener location signal.
